(19) United States
(12) Patent Application Publication
(10) Pub. No.: US 2014/0149422 A1
(43) Pub. Date: May 29, 2014

(54) Automating Management of Social Media Data

(71) Applicant: DELL PRODUCTS L.P., Round Rock, TX (US)

(72) Inventors: George B. Sadler, Round Rock, TX (US); Rajiv Narang, Cupertino, CA (US); Munish Gupta, Austin, TX (US)

(73) Assignee: DELL PRODUCTS L.P., Round Rock, TX (US)

(21) Appl. No.: 13/687,600

(22) Filed: Nov. 28, 2012

(51) Int. Cl. G06F 17/30

(52) U.S. Cl. CPC G06F 17/30321
USPC 707/741

(57) ABSTRACT

A system, method, and computer-readable medium are disclosed for automating the management of social media data. Customer identification information associated with a target individual is processed to generate corresponding social media identification information, which in turn is processed to identify associated social media data stored in a social media data source. Once identified, the associated social media data is retrieved, indexed to the customer and social media identification data, and stored in a social profile associated with the target individual. In various embodiments, the customer identification data comprises one or more of a customer's name, a unique customer identifier, a physical address, an electronic mail address, a telephone number, or a customer demographic.

### BACKGROUND OF THE INVENTION

1. Field of the Invention

The present invention relates to the management of information handling systems. More specifically, embodiments of the invention provide a system, method, and computer-readable medium for automating the management of social media data.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Companies face ongoing challenges in collecting pertinent information related to their customers and using it in an effective manner. These challenges have been exacerbated by the growing popularity of social media in recent years, which enables individuals to publish a daily, sometimes hourly, report of their problems, their needs, their preferences, and their day-to-day activities. As a result, companies are now awash in a flood of all kinds of data about people that was not previously available.

Currently, there is so much information available that it can be difficult to determine whether it will be useful for any particular interaction. Furthermore, this information is often scattered throughout many different systems, both internal and external to a company. Moreover, even if the information exists somewhere, it may not be accessible to the person that needs it, when they need it. As a result, addressing the challenge of how to best utilize this information has become even more critical.

### SUMMARY OF THE INVENTION

A system, method, and computer-readable medium are disclosed for automating the management of social media data. In various embodiments, a social profile data repository is created that contains consolidated social data for a vendor's current and prospective customers. In these and other embodiments, individual social profiles associated with predetermined individuals are created and administered through a customer hub.

In one embodiment, customer identification information associated with a target individual is processed to generate corresponding social media identification information, which in turn is processed to identify associated social media data stored in a social media data source. Once identified, the associated social media data is retrieved, indexed to the customer and social media identification data, and stored in a social profile associated with the target individual. In various embodiments, the customer identification data comprises one or more of a customer's name, a unique customer identifier, a physical address, an electronic mail address, a telephone number, or a customer demographic.

In various embodiments, the associated social media data is identified by performing either probabilistic or deterministic matching operations, or a combination of the two. In various embodiments, the social media data source comprises one or more of a third party data source, a vendor data source, an external social media data source, and an internal social media data source. In various embodiments, the associated social media data comprises updated social media data, which is periodically retrieved from its corresponding social media data source.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 is a general illustration of components of an information handling system as implemented in the system and method of the present invention;

FIG. 2 is a simplified block diagram of a social profile;

FIG. 3 is a simplified block diagram showing the relationship between a plurality of social profile business data objects;

FIG. 4 is a simplified block diagram showing the relationship of a plurality of identifiers business data objects;

FIG. 5 is a simplified block diagram showing the relationship of a plurality of social network business data objects;

FIG. 6 is a simplified block diagram showing the relationship of a plurality of vendor interaction business data objects;

FIG. 7 is a simplified block diagram of a customer hub;

FIG. 8 is a simplified data flow diagram showing the performance of social profile data processing operations;

FIGS. 9a-c are a generalized flowchart showing the performance of social profile data processing operations;

FIG. 10 is a simplified data flow diagram showing periodic scans of a plurality of data sources to maintain a social profile; and

FIG. 11 is a simplified data flow diagram showing a plurality of vendor systems interacting with a customer hub to access data stored in a social profile.

### DETAILED DESCRIPTION

A system, method, and computer-readable medium are disclosed for automating the management of social media data. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

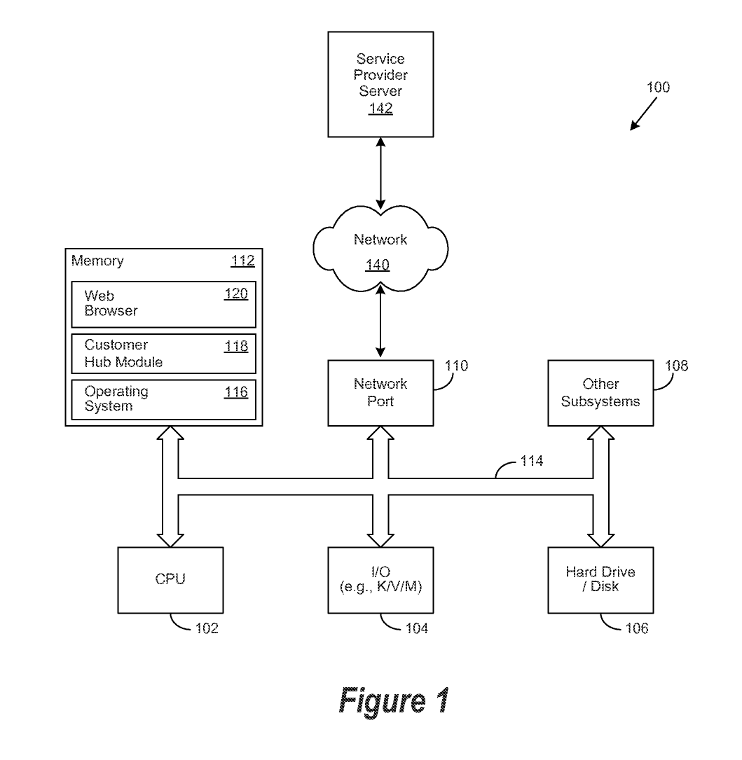

FIG. 1 is a generalized illustration of an information handling system 100 that can be used to implement the system and method of the present invention. The information handling system 100 includes a processor (e.g., central processor unit or “CPU”) 102, input/output (I/O) devices 104, such as a display, a keyboard, a mouse, and associated controllers, a hard drive or disk storage 106, and various other subsystems 108. In various embodiments, the information handling system 100 also includes network port 110 operable to connect to a network 140, which is likewise accessible by a service provider server 142. The information handling system 100 likewise includes system memory 112, which is interconnected to the foregoing via one or more buses 114. System memory 112 further comprises operating system (OS) 116 and in various embodiments may also comprise a customer hub module 118 and a web browser 120. In one embodiment, the information handling system 100 is able to download the customer hub module 118 from the service provider server 142. In another embodiment, the customer hub module 118 is provided as a service from the service provider server 142.

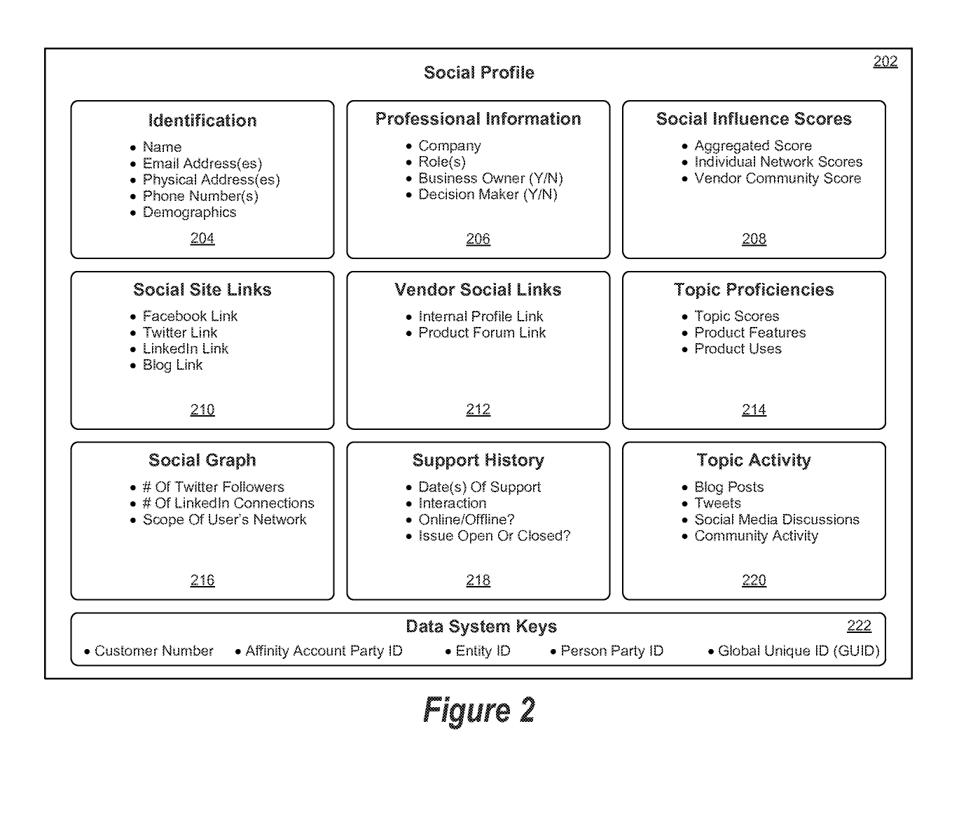

FIG. 2 is a simplified block diagram of a social profile as implemented in accordance with an embodiment of the invention. As used herein, a social profile broadly refers to an aggregated summary of an individual's social activity within predetermined social media environments. In various embodiments, a social profile likewise comprises a summary of a person's social interactions that are currently stored in a vendor's systems. In certain of these embodiments, the social profile may likewise comprise non-social data (e.g., vendor-related data), links to non-social data, or index keys used to access such non-social data stored in other data sources.

Skilled practitioners of the art will be aware that social data related to individuals, such as a vendor's current and prospective customers, is dispersed throughout many vendor systems and the Internet. This dispersion makes it difficult to for a vendor to understand their needs and target solutions for them. Accordingly, it is advantageous for a vendor to consolidate this social data and make it available for access by their systems. As an example, this consolidated social data can be used for social targeting to discover leads by identifying customers that are looking for a solution to a predetermined problem. As another example, the consolidated social data can likewise be used to increase click-through rates by targeting customers with marketing campaigns tailored to their needs. As yet another example, the consolidated social data can be used to increase online revenue per customer by customizing interactions to their specific needs. As still another example, the consolidated social data can be used to drive sales leads by identifying influential customers and leveraging their social network.

From the foregoing, it will be appreciated that multiple departments within a vendor's organization would benefit from the consolidation of social data associated with existing and prospective customers. For example, marketing departments may want to identify all individuals that meet specific criteria based upon social network participation and demographics so they can target that group with specific product messaging. The success of product messaging is typically measured by the sales of products that are targeted to recipients of the messaging.

As another example, a consumer sales department may want to be able to identify sales leads by analyzing a current or prospective customer's social activity and interactions with the vendor sot that they can target individuals that are more likely to be interested in specific products. As yet another example, an online sales department may want to be able to change the messaging and ads shown to a visitor to the vendor's website, based upon that visitor's social and topical activity, to increase online revenue by being more relevant to that visitor's interests. As still another example, a small-to-medium business (SMB) sales department may want to be able to identify the most influential influencers within a social media environment for various vendor-related topics to leverage their influence to drive business.

As another example, a SMB marketing department may want to be able to identify leads by analyzing the social activity of a company's decision makers to identify a group of businesses to target for marketing a specific solution. As yet another example, a marketing department may want to see all social activity data for IT decision makers at a specified company so they can target specific messaging and solutions to them. As stilt another example, a customer service department may want to be able to know the social activity of a caller, as well as their purchasing history and power, on that they can prioritize their service and better address their needs. Likewise, the vendor's information technology (IT) department may want to optimize the matching algorithm used for matching customer data to social data.

In various embodiments, asocial profile data repository is created that contains consolidated social data for a vendor's current and prospective customers. In these and other embodiments, individual social profiles 202 associated with predetermined individuals are created and administered through a customer hub. In this embodiment, a social profile 202 comprises identification 204 data, professional information 206, social influence scores 208, social site links 210, vendor social links 212, topic proficiencies 214, social graph 216 data, support history 218 data, topic activity 220 data, and data system keys 222.

In one embodiment, the identification 204 data comprises data associated with a target individual's name, email and physical addresses, phone number(s) and demographics. In one embodiment, the professional information 206 comprises a target individual's company, their role(s), whether they are a business owner, and whether they are a decision maker. In one embodiment, the social influence scores 208 comprise the targeted individual's aggregated social influence score, their individual social network influence scores, and a vendor community score.

In one embodiment, the social site links 210 comprise links to a target individual's associated social media environments. In one embodiment, the vendor social links 212 comprise the vendor's internal profile link and the vendor's product forum link. In one embodiment, the topic proficiencies 214 data comprises a target individual's topic scores, product features, and product uses. It will be appreciated that it is often difficult collect data related to a target individual's activity on a site, or on atopic. As such, there is value in being able to know the target individual's topical habits and interests, as well as how this topical activity may relate to their social graph, which in turn provides a measure of their influence.

In one embodiment, the social graph 216 data comprises data associated with whom a target individual is connected to within a predetermined social media environment. As such, the social graph 216 data can be useful for identifying those who have influence within social spaces so that they can be targeted more effectively with the hope that they will disseminate their positive interactions with the vendor with those who follow them. In one embodiment, the support history 218 data comprises the date(s) of the support, the support interaction, whether the support interaction occurred offline or online, and whether the issue is closed or still open. In one embodiment, the topic activity 220 data comprises data associated with a target individual's various social media interactions related to a predetermined topic. In one embodiment, the data system keys 222 comprise a target individual's customer number, their affinity account party ID, their entity ID, their person party ID, and a global unique ID.

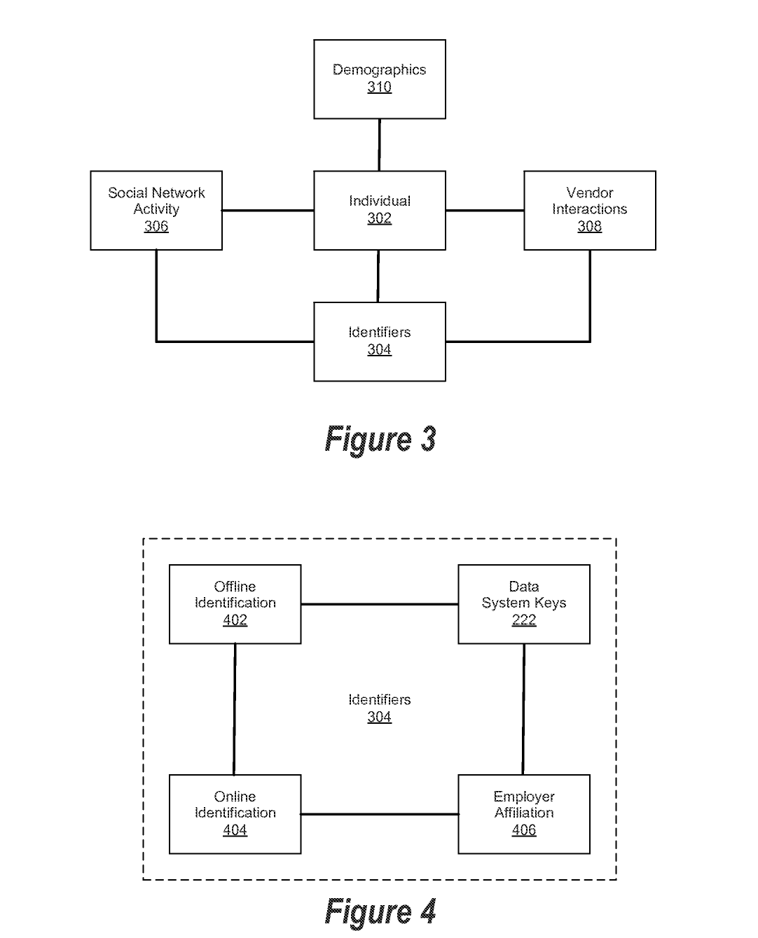

FIG. 3 is a simplified block diagram showing the relationship between a plurality of social profile business data objects as implemented in accordance with an embodiment of the invention. As shown in FIG. 3, the social profile business data objects comprise demographics 310, social network activity 306, vendor interactions 308, and identifiers 304, all of which are associated with a target individual 302. As likewise shown in FIG. 3, the identifiers 304 data object is likewise associated with the social network activity 306 and vendor interactions 308 business data objects. In various embodiments, the demographics 310 business data object may comprise data related to a target individual's 302 age, gender, employment status, salary information, location and so forth. Those of skill in the art will recognize that many such embodiments are possible and that the foregoing is not intended to limit the spirit, scope or intent of the invention.

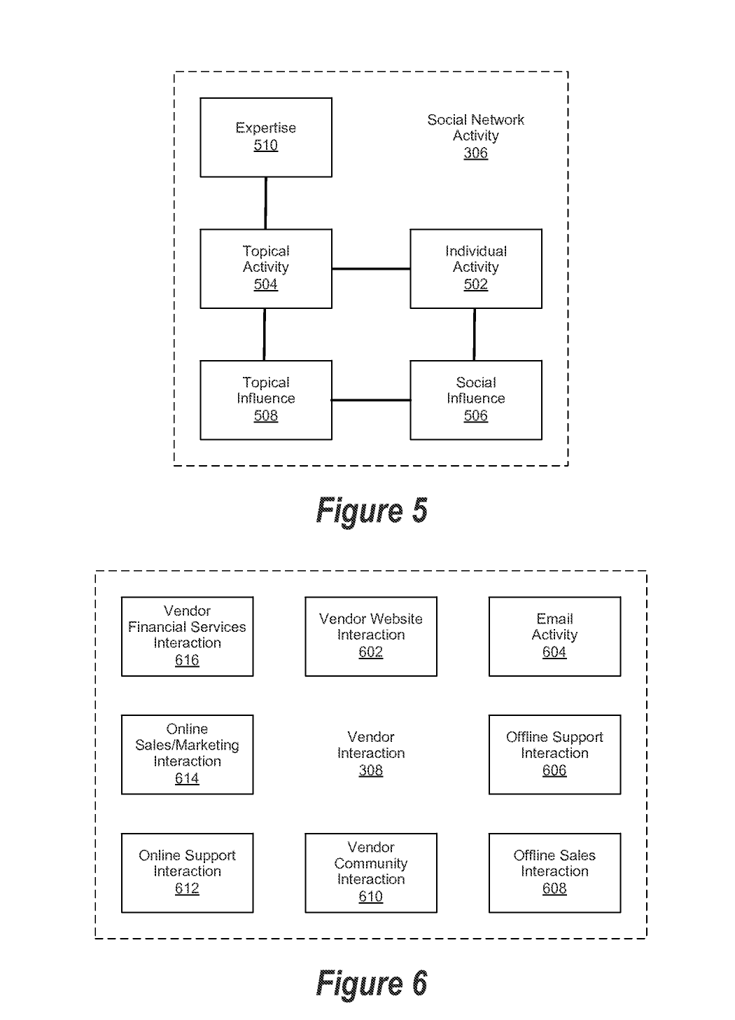

FIG. 4 is a simplified block diagram showing the relationship of a plurality of identifiers business data objects as implemented in accordance with an embodiment of the invention. As shown in FIG. 4, the identifiers 304 business data object comprises offline identification 402, online identification 404, employer affiliation 406, and data system keys 222, all of which are associated with one another. In various embodiments, the offline identification 402 business data object may comprise a target individual's name, address, phone number(s), demographic information, education information, and so forth. In various embodiments, the online information 404 business data object may comprise a target individual's email address(es), social network identifier(s), blog addresses and so forth. In various embodiments, the employer affiliation 406 business data object may comprise a target individual's decision making authority, their employer history, employer history social footprint, and so forth. In various embodiments, the data system keys 222 comprise various index keys associated vendor systems used for customer support, order management, accounting, warranty and so forth. Skilled practitioners of the art will recognize that many such embodiments are possible and that the foregoing is not intended to limit the spirit, scope or intent of the invention.

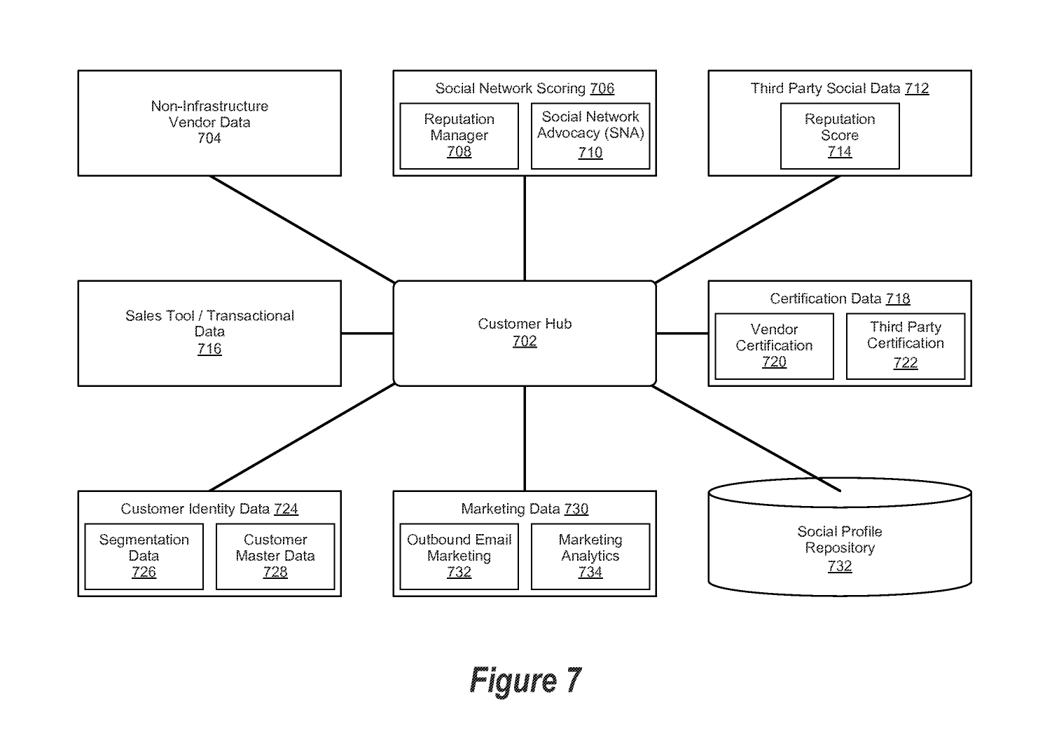

FIG. 5 is a simplified block diagram showing the relationship of a plurality of social network business data objects as implemented in accordance with an embodiment of the invention. As shown in FIG. 5, the social network 306 business data object comprises individual activity 502, topical activity 504, social influence 506, topical influence 508, and expertise 510, all of which are associated with one another. In various embodiments, the individual activity 502 business data object may comprise data related to a target individual's number of social media posts, the frequency of the posts, how recent the posts were made, and so forth. In various embodiments, the topical activity 504 business data object may comprise data related to a target individual's topic proficiencies, social media and blog posts, social community activity, likes, reviews, comments, posts, and so forth. In various embodiments, the social influence 506 business data object may comprise data related to a target individual's social media reputation score, their social graph and connections, their blog subscribers and followers, the number of their social network connections, and so forth. In various embodiments, the topical influence 508 business data object may comprise data related to a target individual's participation and interactions in various social media environments and their respective influence therein. In various embodiments, the expertise 510 business data object may comprise data related to a target individual's expertise in a vertical technology, a horizontal industry, a job role, skills, interests and so forth. Those of skill in the art will recognize that many such embodiments are possible and that the foregoing is not intended to limit the spirit, scope or intent of the invention.

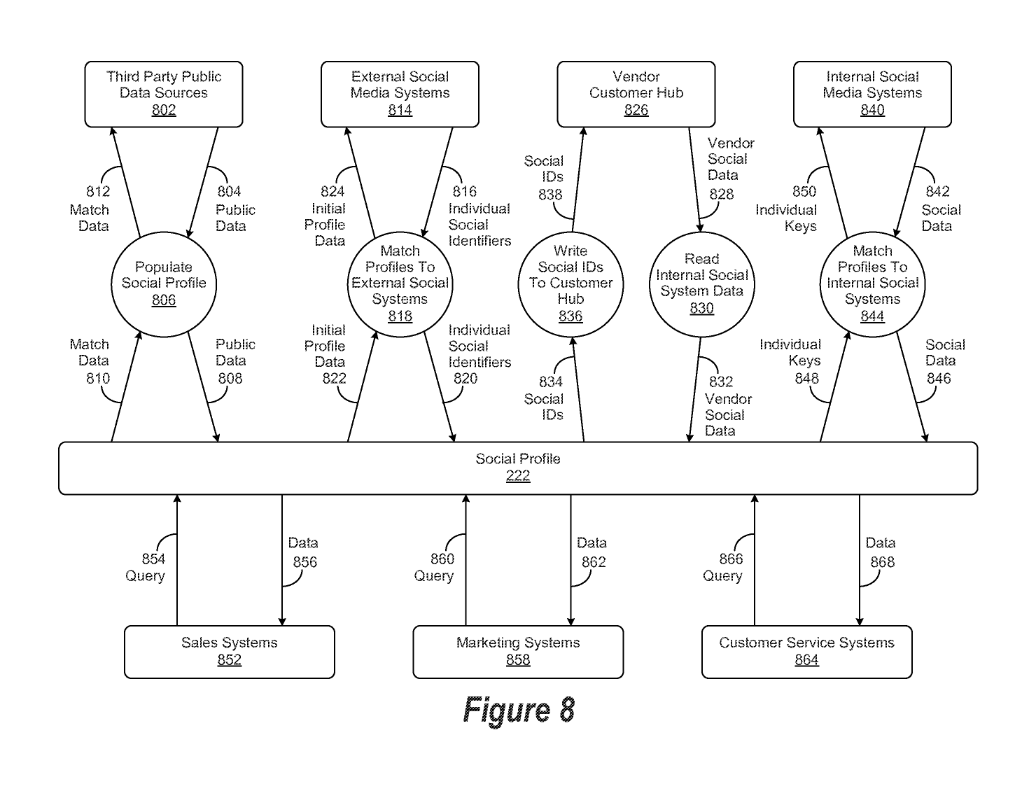

FIG. 6 is a simplified block diagram showing the relationship of a plurality of vendor interaction business data objects as implemented in accordance with an embodiment of the invention. As shown in FIG. 6, the vendor interaction 308 business data object comprises vendor website interaction 602, email activity 604, offline support interaction 606, offline sales interaction 608, vendor community interaction 610, online support interaction 612, online sales and marketing interaction 614, and vendor financial services interaction 616, any of which may or may not be associated with one another. In various embodiments, the vendor website interaction 602 business data object may comprise clickstream data associated with a target individual's interaction with the vendor's website. In various embodiments, the email activity 604 may comprise data associated with email campaigns and a targeted individual's associated click-throughs, responses and other resulting actions. In various embodiments, the offline support interaction 606 may comprise data associated with customer support calls (e.g., who, when, why) and so forth. In various embodiments, the offline sales interaction 608, may comprise data associated with sales leads, sales calls (e.g., who, when, why), vendor calls (e.g., who, when, why) and so forth. In various embodiments, the vendor community interaction 610, may comprise data associated with a target individual's reputation manager scores, segmentation data, forum posts, online recognitions, and so forth. In various embodiments, the online support interaction 612, may comprise data associated with a target individual's online chat support (e.g., who, when, why), email support (e.g., who, when, why), and so forth. In various embodiments, the online sales and marketing interaction 614, may comprise data associated with a target individual's interaction with online sales processes, online marketing campaigns, reviews, and so forth. In various embodiments, the vendor financial services interaction 616 may comprise data associated with a target individual's interaction with a vendors financial services organization. Skilled practitioners of the art will recognize that many such embodiments are possible and that the foregoing is not intended to limit the spirit, scope or intent of the invention.

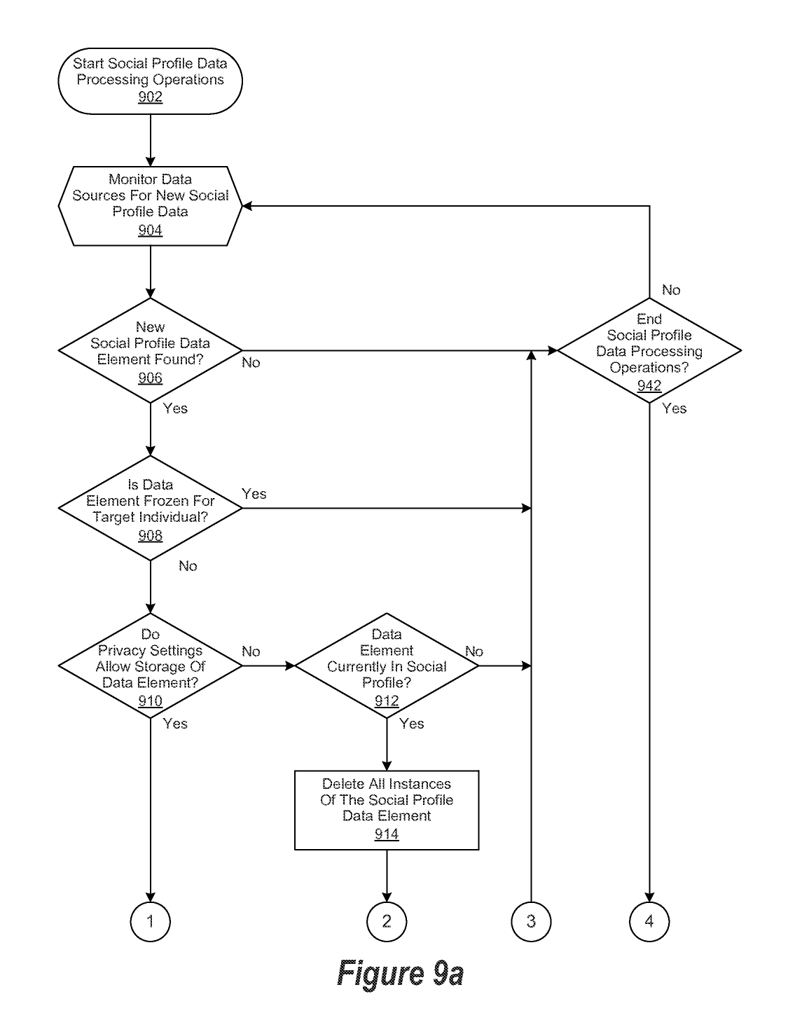

FIG. 7 is a simplified block diagram of a customer hub as implemented in accordance with an embodiment of the invention. In various embodiments, a user hub 702 is implemented to create and access social and other data stored in a social profile. In these and other embodiments, social profiles are created, stored, and subsequently maintained in a social profile repository 732 by the customer hub 702. In certain embodiments, the data sources used to provide social and other data to the social profiles includes non-infrastructure vendor data 704, social network scoring 706 data, third party social data 712, sales tool and transactional data 716, certification 718, customer identity data 724, and marketing data 730.

In one embodiment, the social network scoring data is provided either by a reputation manager 708 system, a social network advocacy (SNA) system, or both. In one embodiment the third party social data 712 is provided by a reputation score 714 system that assigns a reputation score based upon a target individual's social activity. In one embodiment, the sales tool and transactional data 716 is provide by an online sales platform, which collects demographic and sales activity information. In one embodiment, the certification data 718 comprises vendor certification 720 and third party certification 722 data. In one embodiment, the customer identity data 724 comprises either segmentation data 726, customer master data 728, or both. In one embodiment, the marketing data 730 is provided by an outbound email marketing 732 system that tracks conversation rates, click rates, and open rates. In another embodiment, the marketing data 730 is provided by a marketing analytics 732 system familiar to those of skill in the art.

In various embodiments, the customer hub 702 is implemented to make the social profile data stored in the social profile repository 732 accessible to various systems, as well as providing a user interface for both searches and systems administration. In certain embodiments, the customer hub 702 comprises high-level or summary information about a customer that is frequently accessed. In these and other embodiments, more detailed information is stored in other systems and is accessed by using index keys associated with a target individual, which are stored in the customer hub 702.

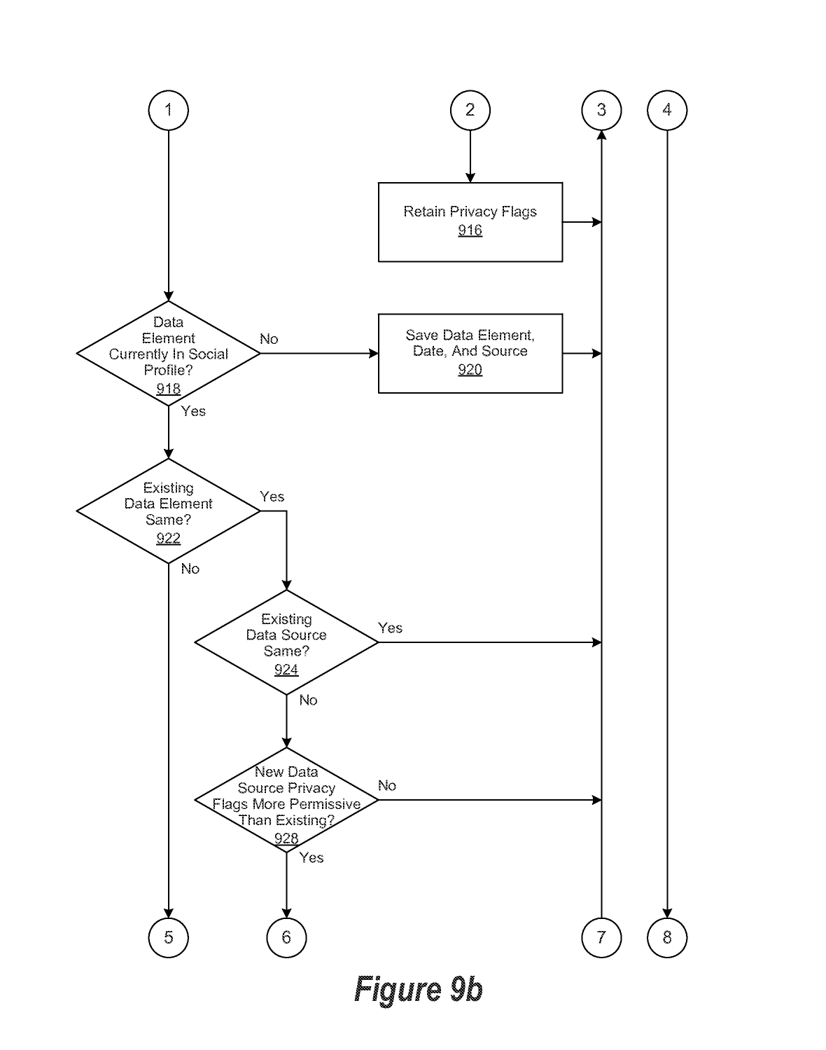

FIG. 8 is a simplified data flow diagram showing the performance of social profile data processing operations implemented in accordance with an embodiment of the invention. In this embodiment, the social profile 222 is first populated in operation 806, which first retrieves matching data 810 from the social profile 222 and submits 812 it to one or more third party data sources. Third party public data is then received 804 and then stored 808 in the social profile 222.

Then, in operation 818, a target individual's external social network identifiers (IDs) are determined by first retrieving 822 initial social profile information, which is then submitted 824 to one or more external social media systems 814. Matching social network IDs are then received 816 and stored 820 in the social profile. In one embodiment, the target individual's profiles are matched by performing probabilistic matching operations. As used herein, probabilistic matching refers to making a match based upon the likelihood that what is known about a predetermined individual aligns with other data that may or may not be associated with the individual. In another embodiment, the new profiles are matched by performing deterministic matching operations. As used herein, deterministic matching refers to a hard match, resulting in a definite yes or no, such as by using a common email address, customer number, or other distinct key field.

Those of skill in the art will be aware that probabilistic matching methods can result in incorrectly sourced data, which may be offset through the implementation of known data governance approaches. Conversely, deterministic matching methods may increase the likelihood of having a correct data set, but at the cost of fewer matches. Furthermore, such approaches involve an iterative process by which matching algorithms are tested, and then refilled, to increase matching yields.

Then, in operation 836, a target individual's social media IDs are retrieved 834 from the social profile 222 and then written 838 to the vendor's customer hub 826. In response, matching vendor social and other data is then received 828 in operation 830 and stored 832 in the social profile 222. Skilled practitioners of the art will recognize the benefit of writing the target individual's external social IDs to the vendor's customer hub 826, as they then become a part of that individual's record, which is continually updated and re-matched as more information about that individual is found.

Then, in operation 844, a target individual's vendor social network and other vendor-related IDs are determined by first retrieving 848 individual keys, which are then submitted 850 to one or more vendor social media or other systems 840. Matching social and vendor-related data is then received 842 and stored 846 in the social profile. Social and other data stored in a target individual's social profile 222 is then respectively accessed by the sales 852, marketing 858, and customer service 864 systems through queries 854, 860, 866 and data provision 856, 862, 868.

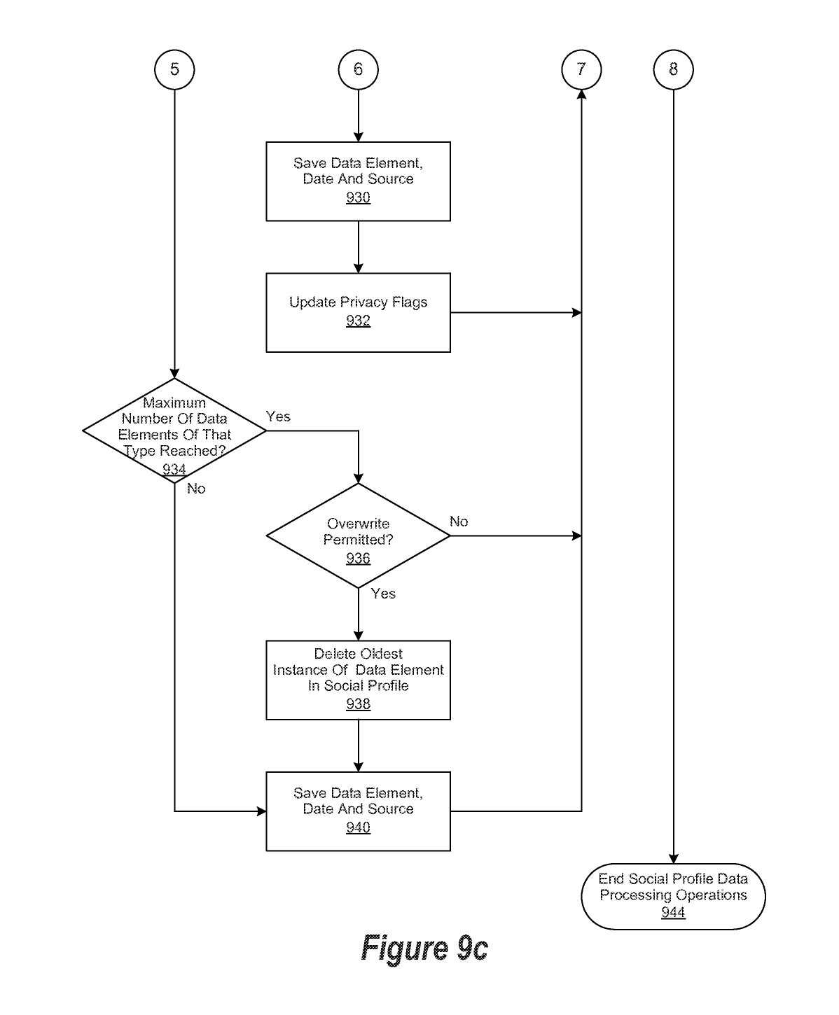

FIGS. 9a-c are a generalized flowchart showing the performance of social profile data processing operations implemented in accordance with an embodiment of the invention. In this embodiment, social profile data processing operations are begun in step 902, followed by monitoring predetermined social data sources for new social profile data elements that are associated with a target individual in step 904. A determination is then made in step 906 whether a new social profile data element has been found. If not, then a determination is made in step 942 whether to end social profile data processing operations. If not, the process is continued, proceeding with step 904. Otherwise, social profile data processing operations are ended in step 944.

However, if it is determined in step 906 that a new social profile data element has been found, then a determination is made in step 908 whether the new social profile data element is frozen for the target individual. If so, then the process is continued, proceeding with step 942. Otherwise, a determination is made in step 910 whether privacy settings associated with the target individual allow the social profile data element to be stored. If not, then a determination is made in step 912 whether the social profile data element currently exists in the target individual's social profile. If not, the process is continued, proceeding with step 942. Otherwise, all instances of the social profile data element are deleted within the target individual's social profile in step 914. The corresponding privacy flags are then retained in the target individual's social profile in step 916 and the process is continued, proceeding with step 942.

However, if it was determined in step 910 that privacy settings associated with the target individual allow the social profile data element to be stored, then a determination is made in step 918 whether the social profile data element currently exists in the target individual's social profile. If not, then the social profile data element, along with its discovery date and source, is stored in the target individual's social profile in step 920 and the process is continued, proceeding with step 942.

However, if it is determined in step 918 that the social profile data element is currently in the target individual's social profile, then a determination is made in step 922 whether the existing social profile data element is the same. If so, then a determination is made in step 924 whether the source of the existing social profile data element is the same. If so, then the process is continued, proceeding with step 942. Otherwise, a determination is made in step 928 whether privacy flags associated with the new social profile data source are more permissive than the privacy flags associated with the current social profile data source. If not, then the process is continued, proceeding with step 942. Otherwise, the social profiled data element, along with its source and date of discovery, are stored in the target individual's social profile in step 930. The privacy flags associated with the social profile data element are then updated in step 932 and the process is continued, proceeding with step 942.

However, if it was determined in step 922 that the existing social profile data element is not the same, then a determination is made in step 934 whether the maximum number of social profile data elements of that type has been reached in the target individual's social profile. If not, then a determination is made in step 936 whether overwriting of an existing social profile data element is permitted. If not, then the process is continued, proceeding with step 942. Otherwise, the oldest instance of the discovered social profile data element type is deleted from the target individual's social profile in step 938. Thereafter, or if it was determined in step 934 that the maximum number of that social profile data element had not been reached, the discovered social profile data element, along with its source and the date of its discovery, are saved in the target individual's social profile in step 940. The process is then continued, proceeding with step 942.

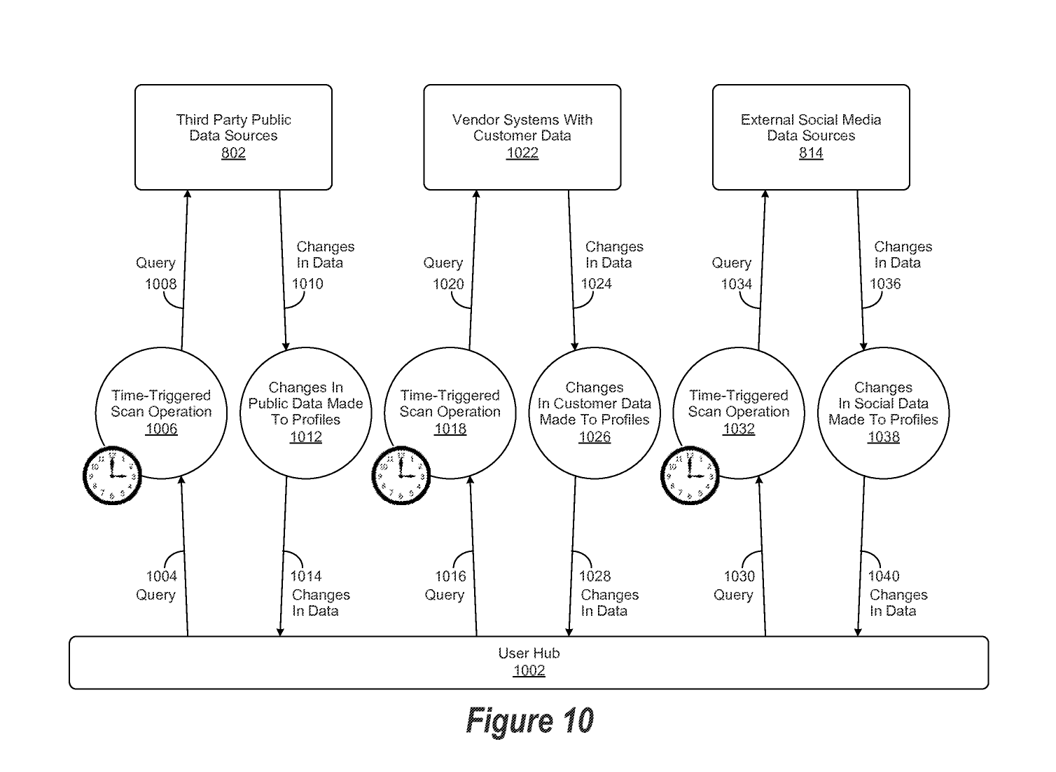

FIG. 10 is a simplified data flow diagram showing periodic scans of a plurality of data sources to maintain a social profile implemented in accordance with an embodiment of the invention. In various embodiments, predetermined data sources, such as third party public data sources 802, vendor systems with customer data 1022, and external social media data sources 814 are periodically accessed by a customer hub 1002 to update social media and other data stored in a social profile. In this embodiment, a time-triggered scan operation is initiated in operation 1006 in response to receiving 1004 a query from the user hub 1002. The query is then submitted 1008 at a predetermined time to one or more third party public data sources 802. Then, in operation 1012, changes in public data associated with a target individual is received 1010 and then provided 1014 to the customer hub 1002. In turn, the customer huh 1002 uses the changes in public data to revise the social profile associated with the target individual as described in greater detail herein.

Likewise, a time-triggered scan operation is initiated in operation 1018 in response to receiving 1016 a query from the user hub 1002. The query is then submitted 1020 at a predetermined time to one or more vendor systems with customer data sources 1022. Then, in operation 1026, changes in the customer data associated with a target individual is received 1024 and then provided 1028 to the customer hub 1002. In turn, the customer hub 1002 uses the changes in customer data to revise the social profile associated with the target individual as described in greater detail herein. Likewise, a time-triggered scan operation is initiated in operation 1032 in response to receiving 1030 a query from the user hub 1002. The query is then submitted 1034 at a predetermined time to one or external social media data sources 814. Then, in operation 1038, changes in the external social media data associated with a target individual is received 1036 and then provided 1040 to the customer hub 1002. In turn, the customer hub 1002 uses the changes in the external social media data to revise the social profile associated with the target individual as described in greater detail herein.

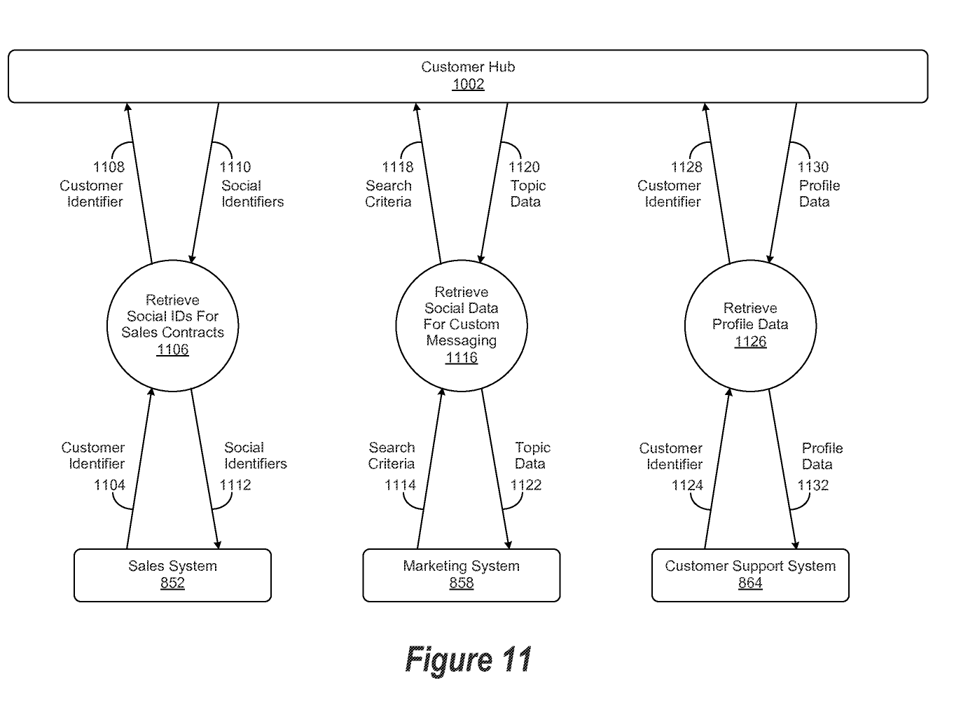

FIG. 11 is a simplified data flow diagram showing a plurality of vendor systems interacting with a customer hub to access data stored in a social profile implemented in accordance with an embodiment of the invention. In various embodiments, predetermined vendor systems, such as sales 852, marketing 858 and customer support 864 systems, interact with a customer hub 1002 to access social media and other data stored in a social profile. In this embodiment, a target individual's social media identifiers (IDs) are retrieved in operation 1106 by first retrieving 1104 their customer ID from a sales system 852 and then submitting 1106 it to the customer hub 1002. In response, one or more social media IDs associated with the target individual are received 1110 and then provided 1112 to the sales system 852 for use in sales contracts or other sales activities.

Likewise, social media data associated with a target individual is retrieved in operation 1116 by first receiving 1114 search criteria from a marketing system 858 and then submitting 1118 it to the customer hub 1002. In response, topic or other social media data associated with the target individual is received 1120 and then provided 1122 to the marketing system 858 for use in custom messaging or other marketing activities. Likewise, profile data associated with a target individual is retrieved in operation 1126 by first receiving 1124 a customer ID from a customer support system 864 and then submitting 1128 it to the customer hub 1002. In response, profile data associated with the target individual is received 1130 and then provided 1132 to the customer support system 864 for use in customer support activities.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

For example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may, be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Consequently, the invention is intended to be limited only by the spirit and scope of the appended claims, giving full cognizance to equivalents in all respects.

1. A computer-implementable method for managing social media data, comprising:
receiving to a computer system customer identification data associated with a user, the customer identification data stored in a customer data record;
processing, via the computer system, the customer identification data to generate social media identification data associated with the user;
processing, via the computer system, the social media identification data to identify associated social media data stored in a social media data source;
retrieving the associated social media data from the social media data source;
performing indexing operations to index the associated social media data to the customer identification data and the social media identification data to provide indexed social media data; and
storing the social media identification data and the indexed social media data in the customer data record; and wherein
the associated social media data is identified by performing matching operations, the matching operations comprising probabilistic matching operations and deterministic matching operations, the probabilistic matching operations comprising making a match based upon a likelihood that what is known about an individual aligns with other data associated with the individual and the deterministic matching operations comprising generating a hard match resulting in a definite yes or no between the associated social media data and the individual.

2. The method of claim 1, wherein the customer identification data comprises at least one of the set of:
a customer name;
a unique customer identifier (ID);
a physical address;
an electronic mail address;
a telephone number; and
a customer demographic.

3-4. (canceled)

5. The method of claim 1, wherein the social media data source comprises at least one of the set of:
a third party public data source;
a vendor data source;
an external social media data source; and
an internal social media data source.

6. The method of claim 1, wherein:
the associated social media data comprises updated social media data; and
the updated social media data is periodically retrieved from the social media data source.

7. A system comprising:
a processor;
a data bus coupled to the processor; and
a non-transitory, computer-readable storage medium embodying computer program code, the non-transitory, computer-readable storage medium being coupled to the data bus, the computer program code interacting with a plurality of computer operations for managing social media data and comprising instructions executable by the processor and configured for:
receiving customer identification data associated with a user, the customer identification data stored in a customer data record;
processing the customer identification data to generate social media identification data associated with the user;
processing the social media identification data to identify associated social media data stored in a social media data source;
retrieving the associated social media data from the social media data source;
performing indexing operations to index the associated social media data to the customer identification data and the social media identification data to provide indexed social media data; and
storing the social media identification data and the indexed social media data in the customer data record; and wherein
the associated social media data is identified by performing matching operations, the matching operations comprising probabilistic matching operations and deterministic matching operations, the probabilistic matching operations comprising making a match based upon a likelihood that what is known about an individual aligns with other data associated with the individual and the deterministic matching operations comprising generating a hard match resulting in a definite yes or no between the associated social media data and the individual.

8. The system of claim 7, wherein the customer identification data comprises at least one of the set of:
a customer name;
a unique customer identifier (ID);
a physical address;
an electronic mail address;
a telephone number; and
a customer demographic.

9-10. (canceled)

11. The system of claim 7, wherein the social media data source comprises at least one of the set of:
a third party public data source;
a vendor data source;
an external social media data source; and
an internal social media data source.

12. The system of claim 7, wherein:
the associated social media data comprises updated social media data; and
the updated social media data is periodically retrieved from the social media data source.

13. A non-transitory, computer-readable storage medium embodying computer program code, the computer program code comprising computer executable instructions configured for:
receiving customer identification data associated with a user, the customer identification data stored in a customer data record;
processing the customer identification data to generate social media identification data associated with the user;
processing the social media identification data to identify associated social media data stored in a social media data source;
retrieving the associated social media data from the social media data source;
performing indexing operations to index the associated social media data to the customer identification data and the social media identification data to provide indexed social media data; and
storing the social media identification data and the indexed social media data in the customer data record; and wherein
the associated social media data is identified by performing matching operations, the matching operations comprising probabilistic matching operations and deterministic matching operations, the probabilistic matching operations comprising making a match based upon a likelihood that what is known about an individual aligns with other data associated with the individual and the deterministic matching operations comprising generating a hard match resulting in a definite yes or no between the associated social media data and the individual.

14. The non-transitory, computer-readable storage medium of claim 13, wherein the customer identification data comprises at least one of the set of:
a customer name;
a unique customer identifier (ID);
a physical address;
an electronic mail address;
a telephone number; and
a customer demographic.

15-16. (canceled)

17. The non-transitory, computer-readable storage medium of claim 13, wherein the social media data source comprises at least one of the set of:
a third party public data source;
a vendor data source;
an external social media data source; and
an internal social media data source.

18. The non-transitory, computer-readable storage medium of claim 13, wherein:
the associated social media data comprises updated social media data; and
the updated social media data is periodically retrieved from the social media data source.
